(19) United States
(12) Patent Application Publication
(10) Pub. No.: US 2003/0219614 A1
(43) Pub. Date: Nov. 27, 2003

(54) Biaxially oriented, hydrolysis-resistant film made from a thermoplastic with a hydrolysis stabilizer, process for producing the film, use of the film, and capacitors produced from the film

(76) Inventors: Holger Kliesch, Mainz (DE); Thorsten Kiehne, Wiesbaden (DE); Franz Hora, Kriftel (DE); Ingo Fischer, Heistenbach (DE)

Correspondence Address: ProPat, L. L. C., 2912 Crosby Road, Charlotte, NC, 28211-2815, US

(21) Appl. No.: 10/441,384

(22) Filed: May 20, 2003

(30) Foreign Application Priority Data
May 21, 2002 (DE) 102 22 348.3

(51) Int. Cl. B32B 27/32

(52) U.S. Cl. 428/523

(57) ABSTRACT

The invention relates to a biaxially oriented, hydrolysis-resistant film made from a thermoplastic and having a thickness in the range from 0.5 to 12 μm. The film comprises at least one hydrolysis stabilizer resistant to evolution of gases and has not only a low hydrolysis rate but also good dielectric properties, and in particular has high dielectric strength. The hydrolysis stabilizer has only low tendency to cause evolution of gases during heating of the film. The invention further relates to a process for producing this film and to the use of the film and also to capacitors produced from the film.

The invention relates to a biaxially oriented, hydrolysis-resistant film made from a thermoplastic and having a thickness in the range from 0.5 to 12 μm. The film comprises at least one hydrolysis stabilizer resistant to evolution of gases and has not only a low hydrolysis rate but also good dielectric properties, and in particular has high dielectric strength. The hydrolysis stabilizer has only low tendency to cause evolution of gases during heating of the film. The invention further relates to a process for producing this film and to the use of the film and also to capacitors produced from the film.

### BACKGROUND OF THE INVENTION

Films made from thermoplastics in the stated range of thickness and suitable for producing film capacitors are well known.

Films for producing capacitors have to meet stringent requirements in relation to their dielectric strength and their dielectric absorption, in order to ensure that the capacitor can withstand sufficiently high voltages, and in order not to become excessively hot during charging and discharging. As described in EP-A-0 791 663 inter alia, this is ensured through high purity of the raw materials used. It is therefore generally necessary to avoid using additives (exceptions being inorganic mineral additives, such as the widely used SiO₂- or CaCO₃-pigments and polymers with very low dielectric constant, such as polystyrene and the like), thus avoiding any adverse effect on electrical properties.

In conventional film capacitors made from thermoplastics, it is generally polyethylene terephthalate homopolymers or polyethylene naphthalate homopolymers that are used. However, polyethylene terephthalate in particular has a tendency toward hydrolytic degradation at temperatures above the glass transition temperature, and particularly above 100° C. Temperatures up to 130° C. and indeed in some cases even higher are, however, not uncommon in many application sectors for film capacitors, e.g. in the automotive sector. Hydrolytic degradation makes the film layers in the capacitor become brittle over time, so that they cause the capacitor to fail. Although polyethylene naphthalate (PEN) is more resistant to hydrolysis, its price is markedly higher, making it uneconomic for most application sectors, and it also degrades markedly on the long use at the temperatures mentioned. If copolyesters, such as polyethylene terephthalate (PET) with a proportion of isophthalic acid, are used instead of homopolymers there is generally a further rise in susceptibility to hydrolysis.

Polyesters more resistant to hydrolysis, obtained by using carbodiimides, are known (U.S. Pat. No. 5,885,709, EP 0 838 500, CH 621 135), as are films and fibers produced therefrom. However, these raw materials and films do not comply with the necessary requirements placed upon dielectric and processing properties for capacitor films.

The unpublished DE Applications 102 09 847.6 and 102 09 850.6 describe hydrolysis-resistant capacitor films and capacitors produced therefrom. The capacitors produced from the films described have better long-term performance than normal PET film capacitors. However, the yield in capacitor production is subject to inexplicable variations, in particular in the case of capacitance drift delta C/C, and this property causes some failures in the event of temperature shocks, for example those occurring during SMD (Surface-Mounting Device) solder processes.

When the films or the capacitors produced therefrom are heated, an unpleasant odor can arise through evolution of gases caused by the hydrolysis stabilizer.

Furthermore, the sectioned surface of the film capacitors described in the two applications has a number of gaps which, although they do not appear to impair electrical performance of the capacitors, cause problems and complaints during further processing.

DE 100 15 658 A1 discloses hydrolysis stabilizers giving little unpleasant odor, e.g. block copolymers based on polycarbodiimides. However, the specification does not mention films treated therewith, or capacitors produced from these films.

It is an object of the present invention to eliminate the disadvantages described of the prior art.

### BRIEF DESCRIPTION OF THE INVENTION

The invention therefore provides a biaxially oriented, hydrolysis-resistant film which comprises a thermoplastic as main constituent and has a thickness in the range from 0.5 to 12.0 μm, preferably from 1.2 to 7.0 μm, has an AC dielectric strength of >190 kV/mm and a roughness Rₐ of <150 nm, and comprises at least one hydrolysis stabilizer resistant to evolution of gases. The invention also provides a process for producing this film and the use of the film, and also capacitors produced from the film.

### DETAILED DESCRIPTION OF THE INVENTION

The film of the invention features hydrolysis resistance, a low level of evolution of off-gases during heating, and high dielectric strength. Furthermore, it can be produced cost-effectively and is suitable for producing electrically stable capacitors which are likewise resistant to hydrolysis. It is moreover suitable for producing hydrolysis-resistant SMD capacitors. A capacitor of this type, often used as suppression capacitor, needs no box, and thus has the advantage of particularly low space requirement, and has longer lifetime than capacitors made from unstabilized thermoplastics.

In addition, the film of the invention can also be recycled without loss of its properties prior to its coating, i.e. prior to capacitor production. The regrind may therefore be reused in the process to produce the film.

High dielectric strength means that the (AC) dielectric strength of the film, measured to DIN 53481 by the ball and plate method with alternating voltage, is ≧190 kV/mm, preferably ≧240 kV/mm, and in particular ≧280 kV/mm.

The expression “electrically stable capacitors” means that the capacitors equipped with the hydrolysis stabilizers have markedly longer lifetime and do not have high failure rates in practical use, when compared with capacitors without hydrolysis stabilizer.

The film comprises a thermoplastic as main constituent. Examples of those suitable are polyethylene terephthalate (PET), polyethylene naphthalate (PEN), polybutylene terephthalate (PBT), bibenzoyl-modified polyethylene terephthalate (PETBB), bibenzoyl-modified polybutylene terephthalate (PBTBB), bibenzoyl-modified polyethylene naphthalate (PENBB), and mixtures of these, preference being given to PET, PEN, and PETBB.

To prepare the thermoplastics, use may be made not only of the main monomers, such as dimethyl terephthalate (DMT), ethylene glycol (EG), propylene glycol (PG), 1,4-butanediol, terephthalic acid (TA), benzenedicarboxylic acid, and/or 2,6-naphthalenedicarboxylic acid (NDA), but also of isophthalic acid (IPA), trans- and/or cis-1,4-cyclohexanedimethanol (c-CHDM, t-CHDM, or c/t-CHDM), and other suitable dicarboxylic acid components (or dicarboxylic esters) and diol components.

For the purposes of the invention, thermoplastics are

homopolymers,

copolymers,

compounded materials,

recycled materials, and

other types of thermoplastics.

Preference is given here to polymers where the dicarboxylic acid component is composed of 95% or more, in particular 98% or more, of TA or NDA. Preference is also given to thermoplastics where the diol component is composed of 90% or more, in particular 93% or more, of EG. Preference is also given to polymers where the diethylene glycol content in the entire polymer is in the range from 1 to 2%. None of the abovementioned quantity data includes the hydrolysis stabilizer.

The film of the invention also comprises inorganic or organic compounds which are needed to adjust the surface topography. However, excessive roughness (Rₐ value) impairs the electrical yield during capacitor manufacture. It has therefore proven advantageous for the roughness values to be adjusted to those described below, which may differ depending on the thickness of the film. The amount of the compounds used depends on the substances used and their particle size. The latter is in the range from 0.01 to 10.0 μm, preferably from 0.1 to 5.0 μm, and in particular from 0.3 to 3.0 μm. In the case of a film of thickness from 3.6 to 12.0 μm, a desired Rₐ value is ≦150 nm and preferably ≦100 nm. In the case of a film of thickness from 2.4 to 3.5 μm, the Rₐ value is ≦100 nm and preferably ≦70 nm, while in the case of films of thickness below 2.4 μm the Rₐ takes values ≦70 nm and preferably ≦50 nm.

Examples of compounds suitable for achieving the roughness are calcium carbonate, apatite, silicon dioxide, titanium dioxide, aluminum oxide, crosslinked polystyrene, zeolites, and other silicates and aluminum silicates. The amounts generally used for these compounds are from 0.05 to 1.5%, preferably from 0.1 to 0.6%. Simple mixing trials followed by measurement of the Rₐ values can readily determine the roughness as a function of the compound used. For example, a combination of the silicon dioxide pigments 0.11% of ®Sylysia 320 (Fuji, Japan) and 0.3% of ®Aerosil TT600 (Degussa, Germany) gives an Rₐ value of 70 nm in the case of a 5 μm film, and similarly a film with a thickness of 5 μm and comprising 0.6% of ®Omyalite (calcium carbonate from Omya, Switzerland) with an average particle size of 1.2 μm gives an Rₐ value of 60 nm. If the same mixing specifications are used to produce a film of thickness 1.4 μm the result is an Rₐ value of 35±5 nm.

To achieve the AC dielectric strength, it has proven advantageous for the average melt resistance of the thermoplastic used to be ≧1·10⁷ Ωcm, preferably ≧10·10⁷ Ωcm, and in particular ≧25·10⁷ Ωcm. The average is determined from the formula

1/(x₁C1/W₁+x₂C1/W₂ . . . +xₙC1/Wₙ),

where x₁ (xₙ)=proportion of thermoplastic chips of component 1 (n) and W₁ (Wₙ)=resistance of thermoplastic chips of component 1 (n).

The standard viscosity SV (DCA) of the film, measured in dichloroacetic acid to DIN 53728, is generally in the range from 700 to 1100, preferably from 800 to 980.

The film also comprises a hydrolysis stabilizer resistant to evolution of gases, preferably fed by way of what is known as masterbatch technology directly during film production, the proportion of the hydrolysis stabilizer being in the range from 0.2 to 10.0% by weight, preferably from 1.0 to 4.0% by weight, based on the weight of the thermoplastic. The proportion of the hydrolysis stabilizer in the masterbatch is generally from 5.0 to 60.0% by weight, preferably from 10.0 to 50.0% by weight, based in each case on the total weight of the masterbatch.

Suitable hydrolysis stabilizers here are polymeric carbodiimides with a low level of gas evolution, e.g. block copolymers based on polycarbodiimides of the formula (I)

X—[—(A)ₘ—(B)ₙ—]ₒ—X (I)

where

X is identical or different and selected from the group —NHCO—R, —NHCONH—R, —NHCOO—R, —HCOS—R, —COO—R, —O—R, —NR₂, —NHR, and —NCO, where the radicals R are an alkyl, cycloalkyl, aralkyl, or aryl radical having from 1 to 30 carbon atoms, m and n, independently of one another, are an integer from 1 to 1000, o is an integer from 1 to 500,

A has been selected from the group of the carbodiimides or polycarbodiimides of the formula (II)

—(—N═C═N—Y—)— (II)

where

Y has been selected from the group of ortho- or bisortho-substituted aromatics, of aralkylenes where the carbon atom bonded to the carbodiimide group has substitution by C₁-C₁₄-alkyl groups, and of cycloalkylenes where the carbon atom bonded to the carbodiimide group has substitution by C₁-C₁₄-alkyl groups, and B has been selected from the group (poly)diols, (poly)diamines, (poly)dimercaptans, (poly)amino alcohols, (poly)aminomercaptans, and (poly)mercapto alcohols.

Preference is given to block copolymers where Y in the formula (II) is a block based on 2,4,6-triisopropylphenyl 1,3-diisocyanate or 3,3′,5,5′-tetraisopropyl-4,4′-diisocyanatodiphenylmethane. Mixtures of the compounds mentioned are likewise suitable.

Other suitable polymeric carbodiimides have the formula (III)

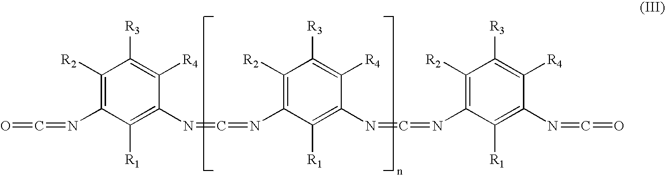

where R₁, R₂, and R₄ are identical and are a hydrocarbon radical of the formula CₚH₍₂ₚ₊₁₎, where p is an integer ≧3, preferably ≧5, and n≦12, and R₃ is hydrogen.

Carbodiimides of the formula (III) whose structure is based on naphthalene rings are also suitable. In the case of these compounds, the naphthalene structure is built up by way of the configuration (IV) for the radicals R₂ and R₃ or R₃ and R₄

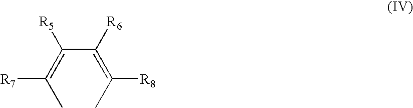

where R₁. and R₄ or, respectively, R₄. and R₂ are hydrogen. R₅ to R₈ may likewise be hydrogen or hydrocarbon radicals of the formula CᵣH₍₂ᵣ₊₁₎, where r≦10. Other suitable compounds are those where R₅ and R₆ are identical or different and are a hydrocarbon radical CᵣH₍₂ᵣ₊₁₎, while the other radicals are hydrogen.

The hydrolysis stabilizer is preferably added by way of masterbatch technology. For this, it is first completely dispersed in a carrier material. The carrier material used may comprise the thermoplastic itself, e.g. the polyethylene terephthalate, or else other polymers compatible with the thermoplastic. Once fed to the thermoplastic for film production, the constituents of the masterbatch melt during the extrusion process, and are thus dispersed in the thermoplastic.

The masterbatch may also be prepared in situ, i.e. the monomers for preparing the thermoplastic are mixed with the other components, e.g. the hydrolysis stabilizers and/or the compounds for achieving roughness, and the resulting mixtures are polycondensed.

Surprisingly, it has been found that the stability of the capacitors—in particular with respect to temperature shocks—improves substantially when using the inventive hydrolysis stabilizers resistant to evolution of gases if the weight loss through gas evolution is extremely small when comparison is made with commercially available hydrolysis stabilizers, e.g. P100 (Rheinchemie, Germany) under the same test conditions. For example, it is advantageously lower than the comparison by 5%, preferably by 10%, and in particular by 20%. The gas evolution here is measured as the weight loss from a 15% strength masterbatch of the hydrolysis stabilizer (percentages by weight) in PET (SV 750-830) during thermogravimetric analysis at 230° C. (see test methods).

The film capacitors produced from the films of the invention also have statistically fewer gaps than those produced using commercially available stabilizers.

Besides the additives mentioned, other components may also be present in the film, examples being flame retardants and/or free-radical scavengers, and/or other polymers, such as polyetherimides.

Cost-effective production includes the capability of the polymers or polymer components needed for production of the film to be dried using standard industrial driers, such as vacuum driers (i.e. under reduced pressure), fluidized-bed driers, or fixed-bed driers (tower driers). It is important that these polymers neither cake nor become thermally degraded. The driers mentioned generally operate at atmospheric pressure with temperatures of from 100 to 170° C., at which prior-art polymers with hydrolysis stabilizer can cake and clog the driers and/or extruders. In the case of a vacuum drier, which provides the mildest drying conditions, the polymer traverses a temperature range from about 30 to 130° C. at a reduced pressure of 50 mbar. Even in the case of these driers with drying temperatures below 130° C., capacitor film production requires after-driers (hoppers) with temperatures above 100° C., at which similar modified prior-art polymers can then cake. After-drying in a hopper at temperatures of from 100 to 130° C. is generally required, with a residence time of from 3 to 6 hours.

The film of the invention is generally produced by extrusion processes known per se.

The procedure for one of these processes is that the appropriate melts are extruded through a flat-film die, the resultant film is drawn off and quenched in the form of a substantially amorphous prefilm on one or more rolls (chill rolls) for solidification, and the film is then reheated and biaxially stretched (oriented), and the biaxially 10 stretched film is heat-set.

The biaxially stretching is generally carried out sequentially. It is preferable here to stretch first longitudinally (i.e. in machine direction, =MD) and then transversely (i.e. perpendicularly to machine direction, =TD). This leads to orientation of the molecular chains. The longitudinal stretching can be carried out with the aid of two rolls running at different speeds corresponding to the desired stretching ratio. For the transverse stretching, an appropriate tenter frame is generally utilized.

The temperature at which the stretching is carried out may vary within a relatively wide range, and depends on the desired properties of the film. Both the longitudinal and the transverse stretching are generally carried out at from TG+10° C. to TG+60° C. (TG=glass transition temperature of the film). The longitudinal stretching ratio is generally in the range from 2.0:1 to 6.0:1, preferably from 3.0:1 to 4.5:1. The transverse stretching ratio is generally in the range from 2.0:1 to 5.0:1, preferably from 3.0:1 to 4.5:1, and that for any second longitudinal and transverse stretching carried out is from 1.1:1 to 5.0:1.

Where appropriate, the first longitudinal stretching may be carried out simultaneously with the transverse stretching (simultaneous stretching). It has proven particularly advantageous for the stretching ratio to be greater than 3.5, both longitudinally and transversely.

In the heat-setting which follows, the film is held at a temperature of from 180 to 260° C., preferably from 220 to 245° C., for about 0.1 to 10 s. Following the heat-setting, or beginning during the heat-setting, the film is relaxed by from 0 to 15%, preferably by from 1.5 to 8%, transversely and, where appropriate, also longitudinally, and the film is cooled and wound up in the usual way. To produce capacitors suitable for SMD processes, the level of relaxation has to be at least 6%, and at least 2% relaxation must take place at temperatures below 190° C.

After wind-up, the film is metallized by the known processes in conventional metallizing machines (e.g. from Applied Films, formerly Leybold) (coating with another conductive material, such as conductive polymers, likewise being possible), and is thermoprocessed to give the desired width for capacitor production. These narrow metallized cuts are used to manufacture capacitor windings, then pressed flat (temperatures from 0 to 280° C.), subjected to the Schoop process, and provided with contacts.

Another method is winding of the narrow cuts onto wheels or rods, which are subjected to the Schoop process, heat-stabilized in an oven (temperatures of from 100 to 280° C.), and cut to the appropriate capacitor widths (film capacitors), these finally then being provided with contacts. Where appropriate, the heat-conditioning here may also take place prior to the Schoop process.

The lifetime of capacitors made from films with hydrolysis stabilizers increases by a factor of more than two over capacitors using conventional films. Another surprising factor here is that the lifetime of the capacitors produced from PEN films with hydrolysis stabilizer again increases dramatically and is in the region of capacitors based on polyphenylene sulfide (PPS).

Another particularly surprising factor was the high dielectric strength of the films of the invention and the very good electrical properties. The films are therefore particularly well suited to the production of capacitors, preferably starter capacitors and depression capacitors with SMD-soldering capability. For example, the passage of high currents does not lead to higher failure rates for these capacitors in the voltage test, or in terms of their service life.

It was also surprising that use of the hydrolysis stabilizers used in the present invention can again improve electrical properties, e.g. capacity drift, over the prior art.

In the examples below, each of the properties was measured in accordance with the stated norms or methods.

Test Methods

Standard viscosity (SV) and intrinsic viscosity (IV)

Standard viscosity SV (DCA) is measured at 25° C. in dichloroacetic acid (DCA) by a method based on DIN 53726. Intrinsic viscosity (IV) is calculated as follows from standard viscosity

IV=[η]=6.907·10⁻⁴ SV (DCA)+0.063096 [dl/g]

Roughness

Roughness Rₐ of the film is determined to DIN 4768 with a cut-off of 0.25 mm.

Dielectric Strength

Dielectric strength is stated to DIN 53481 for alternating voltage (50 Hz) as average of 10 measurements.

Voltage Test

A voltage is applied to 100 examples of the capacitors manufactured, in each case for 2 seconds. The voltage depends on the thickness of the film used and is calculated from:

voltage in volts=69· (thickness in μm)^{1.3629}

The voltage test for each capacitor is passed if the voltage does not fall by more than 10% during the two seconds. The entire test is passed if not more than 2 of the capacitors used fail.

Service Life

100 capacitors are stored in an autoclave at 50% rel. humidity for 500 hours at 125° C., and subjected to the voltage test prior to and after this period. The test is passed if not more than 2 of the capacitors used, which at the outset have passed the voltage test, fail after heat-conditioning.

Melt Conductivity/Melt Resistance

15 g of polymer are placed in a glass tube and dried at 180° C. for 2 hours. The tube is immersed in a oil bath heated to 285° C. and evacuated. The melt is freed from bubbles (defoamed) by stepwise reduction of the pressure to 0.1·10⁻² bar. The tube is then flushed with nitrogen, and two electrodes preheated to 200° C. (two platinum sheets (area=1 cm²) separated from one another by 0.5 cm) are then slowly immersed in the melt. The test, using a test voltage of 100 V (Hewlett Packard 4329 A High Resistance Meter), is carried out after 7 minutes, the measured value being taken two seconds after applying the voltage.

Visual Assessment of Gaps on Sectioned Edge 100 capacitors which have passed the voltage test are placed in an oven at 200° C. for 3 minutes. The sectioned edge is then visually checked for gaps. The test is successfully passed if visible gaps have appeared in the sectioned edge of fewer than 5% of the capacitors.

Capacitance Drift

The capacitance of 100 capacitors which have passed the voltage test is measured, and the capacitors are placed in an oven at 200° C. for 3 minutes. The capacitance of each capacitor is then again determined. The test is passed if an unacceptable capacitance drift (capacitance prior to test/capacitance after test·100) of more than 7% arises in fewer than 5% of the capacitors.

Thermogravimetric Test

15 mg of a masterbatch of 15% by weight of hydrolysis stabilizer in each of PET and PEN or in an appropriate polyester described above are conditioned for 24 h in a drying cabinet at 60% relative humidity and 25° C., as are 15 g of masterbatch with hydrolysis stabilizer P100 (Rheinchemie) as comparison in a polyester which is otherwise identical. The two specimens are then tested in a TGA device (Perkin Elmer TGA7). The gas used comprises air with a gas velocity of 20 ml/min. These specimens are first heated from room temperature to 100° C. within 2 minutes. They are then held at 100° C. for 10 minutes. The weight measured after these 12 minutes is set as 100%. The actual test then begins. The material is heated to 200° C. at a heating rate of 10 K/min, held isothermally at this temperature for 10 minutes, and then heated to 230° C. at a heating rate of 10 K/min, and held isothermally at that temperature for 10 minutes, and the weight loss is read off.

### EXAMPLES

Films of varying thickness are used in each of the examples below and the comparative examples, these films having been produced by a known extrusion process. Capacitors were manufactured from each of the films obtained.

Film Production

Thermoplastic chips were mixed in the ratios given in the examples and precrystallized in a fluidized-bed drier at 155° C. for 1 minute, then dried at 150° C. in a tower drier for 3 hours, and extruded at 290° C. The molten polymer was drawn off from a die by way of a take-off roll. The film was stretched by a factor of 3.8 in machine direction at 116° C. and by a factor of 3.7 transversely in a frame at 110° C. The film was then heat-set at 235° C. and relaxed transversely, first by 5% at temperatures of from 220 to 190° C. and then again by 2% at from 190 to 150° C.

Capacitor Production

Each film was given a vapor-deposited aluminum layer of thickness about 500 Ångstrøm. Masking strips were used to produce an unmetallized strip of width 2 mm between each of the metallized strips of width 18 mm, and the film was then cut into strips of width 10 mm so that the unmetallized strip (free edge) of width 1 mm remained at the edge. Two strips each of length 600 meters, one with the free edge on the left-hand side and one with the free edge on the right-hand side, were wound together onto a metal wheel of diameter 20 cm. There was an offset between the two strips here, amounting to 0.5 mm in the direction of width. 10 layers of unmetallized film were wound up both above and below the metallized strips. A metal tape was drawn tight over the uppermost layer, using a pressure of 0.1 kg/cm². The winding on the wheel was then subjected to the Schoop process on both sides, provided with a vapor-deposited silver layer of thickness 0.2 mm, and heat-conditioned at 195° C. for 60 minutes in an oven (flushed with dry nitrogen). The metal tape was then removed from the wheel winding, and the material was then cut at intervals of 0.7 cm to give separate capacitors.

Carbodiimide Syntheses

a) 293.0 g (1.03 mol) of 2,4,6-triisopropylphenyl 1,3-diisocyanate with an NCO content of 29.5% by weight were heated to 100° C. in the presence of 0.2% by weight (0.59 g) of 1-methylphospholene 1-oxide in 200 ml of anhydrous xylene, and condensed at this temperature with evolution of CO₂. Once the NCO content of the reaction mixture had reached 5.0% by weight, reaction time about 11 hours, the solvent, residual monomers, and catalyst residues were distilled off at reduced pressure.

Yield: 270.2 g of a mixture of oligomeric polycarbodiimides with an NCO content of 7.0% by weight and a carbodiimide content of 12.6% by weight.

b) 500 g (1.2 mol) of 3,3′,5,5′-tetraisopropyl-4,4′-diisocyanatodiphenylmethane with an NCO content of 19.3% by weight were heated to 120° C. in the presence of 0.2% by weight of 1-methylphospholene 1-oxide in 500 ml of anhydrous xylene, and condensed at this temperature with evolution of CO₂. Once the NCO content of the reaction mixture had reached 2.9% by weight, reaction time about 10 hours, the solvent, residual monomers, and catalyst residues were distilled off at reduced pressure.

Yield: 280 g of a mixture of oligomeric polycarbodiimides with an NCO content of 2.3% by weight, a carbodiimide content of 9.4% by weight, a glass point of 58° C., and an average molar mass of 3200 g/mol, measured by gel permeation chromatography.

Block Copolymer Syntheses

A) 85 g of the oligomeric polycarbodiimide from a) were added to 100 ml of anhydrous toluene, and stirred at 60° C. for 10 minutes, under nitrogen. 16.3 g (0.14 mol) of pulverized 2,2-bis(4-hydroxyphenyl)propane were then added in portions, followed by 1.5 g of catalyst—in the form of a 33% strength solution of triethylenediamine in dipropylene glycol. The mixture was heated at reflux for 12 hours, and then the solvent was distilled off under reduced pressure.

Yield: 93 g of a friliable powder with an NCO content of 0%, a carbodiimide content of 10.6% by weight, a glass point of 75.2° C., and an average molar mass of 5300 g/mol.

B) 100 g of the oligomeric polycarbodiimide from b) were added to 100 ml of anhydrous toluene, and stirred at 60° C. for 10 minutes, under nitrogen. 29.4 g of Desmophen 1600 u, a linear polyester from Bayer AG with a hydroxy value of 110.3 mg KOH/g and a viscosity of 220 mPas, measured at 23° C., were added, as was 0.3 g of the catalyst dibutyltin dilaurate. The reaction mixture was stirred at 80° C. for 3 hours, and the solvent was distilled off under reduced pressure.

Yield: 77.4 g of a friliable, amber-colored block copolymer with an NCO content of 0%, a carbodiimide content of 7.3% by weight, and a glass point of 36.3° C.

Polymers Used

Polymers used

| | |
|---|---|
| Polymer | PET (KoSa grade M 03), SV value 820. |
| R1 | |
| Polymer | PEN, SV value 900. |
| R2 | |
| Masterbatch | 15.0% by weight of stabilizer P100 and 85.0% by weight of |
| MB1 | PET, SV value 860. |
| Masterbatch | 1.0% by weight of Sylysia 320, 3.0% by weight of Aerosil |
| MB2 | TT600, and 96.0% by weight of PET, SV value 800. |
| Masterbatch | 15.0% by weight of block copolymer A) and 85.0% by |
| MB3 | weight of PEN, SV value 900. |
| Masterbatch | 1.0% by weight of Sylysia 320, 3.0% by weight of Aerosil |
| MB4 | TT600, and 96.0% by weight of PEN, SV value 900. |
| Masterbatch | 15.0% by weight of block copolymer B) and 85.0% by |
| MB5 | weight of PET, SV value 860. |

The melt resistance of the polymers used was in the range from 25·10⁷ to 30·10⁷ Ωcm.

TGA shows that the weight loss from masterbatch 1 is 0.17%, the weight loss from masterbatch 3 is 0.05%, and the weight loss from masterbatch 5 is 0.1%.

### Example Film Thickness Composition

| | Film thickness | |
|---|---|---|
| Example | (μm) | Composition |
| 1 | 2.0 | 11.0% by weight of MB2, 10.0% by weight |
| | | of MB5, and 79.0% by weight of R1 |
| 2 | 6.0 | 8.0% by weight of MB2, 10.0% byweightof |
| | | MB5, and 82.0% by weight of R1 |
| 3 | 6.0 | 8.0% by weight of MB4, 10.0% by weight of |
| | | MB3, and 82.0% by weight of R2, extrusion |
| | | temperature 305° C., stretching processes at |
| | | 141° C. |

### Comparative Examples

| Comparative | | |
|---|---|---|
| examples | | |
| CE1 | 2.0 | 11.0% by weight of MB2 and 89.0% by |
| | | weight of R1 |
| CE2 | 6.0 | 8.0% by weight of MB2 and 92.0% by |
| | | weight of R1 |
| CE3 | 2.0 | 11.0% by weight of MB2, 10.0% by weight |
| | | of MB1, and 79.0% by weight of R1 |
| CE4 | 6.0 | 8.0% by weight of MB2, 10.0% by weight of |
| | | MB1, and 82.0% by weight of R1 |

The table below gives the properties of the films produced.

| | | E1 | E2 | E3 | CE1 | CE2 | CE3 | CE4 |
|---|---|---|---|---|---|---|---|---|
| Thickness | μm | 20 | 60 | 60 | 2 | 6 | 20 | 60 |
| Roughness Rₐ | nm | 40 | 67 | 62 | 45 | 61 | 40 | 56 |
| Dielectric | V/μm | 304 | 315 | 318 | 312 | 320 | 317 | 320 |
| strength | | | | | | | | |
| Capacitance | +/− | + | + | + | −− | −− | − | − |
| drift | | | | | | | | |
| Voltage test | +/− | + | + | + | + | + | + | + |
| Service life | +/− | + | + | ++ | − | − | + | + |
| Visual test for | +/− | + | + | + | (+) | (+) | − | − |
| gaps | | | | | | | | |
| SV | | 883 | 894 | 895 | 783 | 775 | 877 | 891 |

++ = very good + = good (+) = moderate − = poor −− = very poor

1. A biaxially oriented, hydrolysis-resistant film which comprises a thermoplastic as main constituent and has a thickness in the range from about 0.5 to about 12.0 μm, which has an AC dielectric strength of ≧ about 190 kV/mm and a roughness Rₐ of about ≦150 nm, and comprises at least one hydrolysis stabilizer resistant to evolution of gases.

2. The film as claimed in claim 1, wherein the thermoplastic is a polyethylene terephthalate, polybutylene terephthalate, polyethylene naphthalate, bibenzoyl-modified polyethylene terephthalate, or a mixture of these.

3. The film as claimed in claim 1, wherein the concentration of the hydrolysis stabilizer is in the range from about 0.2 to about 10.0% by weight.

4. The film as claimed in claim 1, wherein the hydrolysis stabilizer comprises block copolymers based on polycarbodiimides of the formula (I)
X—[—(A)ₘ—(B)ₙ—]ₒ—X (I)
where
X is identical or different and selected from the group consisting of —NHCO—R, —NHCONH—R, —NHCOO—R, —HCOS—R, —COO—R, —O—R, —NR₂, —NHR, and —NCO, where the radicals R are an alkyl, cycloalkyl, aralkyl, or aryl radical having from 1 to 30 carbon atoms,
m and n, independently of one another, are an integer from 1 to 1000,
o is an integer from 1 to 500,
A is selected from the group consisting of the carbodiimidies or polycarbodiimides of the formula (II)
—(—N═C═N—Y—)— (II)
where
Y is selected from the group consisting of ortho- or bisortho-substituted aromatics, of aralkylenes where the carbon atom bonded to the carbodiimide group is substituted by C₁-C₁₄-alkyl groups, and of cycloalkylenes where the carbon atom bonded to the carbodiimide group is substituted by C₁-C₁₄-alkyl groups, and
B is selected from the group consisting of (poly)diols, (poly)diamines, (poly)dimercaptans, (poly)amino alcohols, (poly)aminomercaptans, and (poly)mercapto alcohols.

5. The film as claimed in claim 1, which has a dissipation factor tangent delta of ≦ about 0.0075 at 1 kHz and 30° C. and a tangent delta of ≦ about 0.3 at 1 kHz and 120° C.

6. A process for producing a biaxially oriented, hydrolysis-resistant film which comprises a thermoplastic as main constituent and has a thickness in the range from about 0.5 to about 12 μm, which comprises extruding a thermoplastic and a hydrolysis stabilizer resistant to evolution of gases to give a flat melt film, quenching the material with the aid of a chill roll, and drawing off the resultant substantially amorphous film for solidification on one or more rolls, then biaxially stretching (orienting) the film, and heat-setting the biaxially stretched film and providing the film with a conductive coating.

7. The process as claimed in claim 6, wherein the amount of hydrolysis stabilizer, which is added by way of masterbatch technology, is from about 5.0 to about 60.0% by weight, based on the total weight of the masterbatch, alongside the thermoplastic in the masterbatch.

8. Method of making a capacitor which method comprises converting a film as claimed in claim 1 into a capacitor.

9. The method as claimed in claim 8 wherein the capacitor is a starter capacitor or suppression capacitor.

10. The method as claimed in claim 8, wherein the capacitor is a capacitor with SMD capability.

11. A starter capacitor comprising a film as claimed in claim 1.
